(19) United States
(12) Patent Application Publication
(10) Pub. No.: US 2014/0359579 A1
(43) Pub. Date: Dec. 4, 2014

(54) COMBINED DATA AND INSTRUCTION TEST CONTENT

(71) Applicant: Microsoft Corporation, Redmond, WA (US)

(72) Inventors: Ryan J. Cavanaugh, Seattle, WA (US); William J. Ticehurst, Seattle, WA (US)

(21) Appl. No.: 13/906,708

(22) Filed: May 31, 2013

(51) Int. Cl. G06F 11/36

(52) U.S. Cl. CPC G06F 11/362
USPC 717/124

(57) ABSTRACT

A test can include a combination of data and instructions encoded in a programming-language source file. The data can embedded within one or more programming constructs that are not subject to execution such as comments. The instructions can operate on the data. Additionally, various metadata can be included within one or both of a data portion and an instruction portion to facilitate specification of instructions that interact with data, among other things. The test can be subject to pre-processing to at least extract data and compile instructions. The compiled instructions can be executed over the data loaded on a system-under-test, and a determination can be made based thereon as to whether the system is operating correctly.

### BACKGROUND

Testing generally pertains to determining whether a system, such as a software application, operates correctly. More specifically, testing is a process of locating and reporting defects (a.k.a. bugs) and ensuring the defects are fixed by generating and executing tests on a system under test. In other words, testing is a cyclic workflow including running generated tests and fixing defects. As a result, testing can improve the quality and reliability of a system.

A test comprises a set of conditions under which a determination can be made as to whether a system is operating correctly with respect to a system requirement. An instance of a test, or test case, is characterized by a known input and an expected output determined prior to test execution. For example, data acquired from an external data source (e.g., database, XML document . . . ) can be input to a system under test, and a result produced in response to the input can be compared with an expected output to determine whether the system passed the test.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to tests that combine data and instructions. Data and instructions can be collocated and encoded within a programming-language source file. Data can be delimited within a programming language by at least one character denoting non-executing code. In one embodiment, the data can be encoded within a comment and distinctly annotated therein. Instructions can be specified to operate on the data in the programming language syntax. Further, various metadata can be included within one or both of a data portion and an instruction portion to facilitate specification of instructions that interact with data, among other things. A test file that combines data and instructions can be pre-processed to at least extract data and compile the instructions. During testing, the data can be loaded with respect to a system under test and the instructions executed on the data in an attempt to verify correct operation of the system under test.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a test generation system.

FIG. 2 is a block diagram of a test execution system.

FIG. 3 is a block diagram of a representative pre-process component.

FIG. 4 is a flow chart diagram of a test generation method.

FIG. 5 is a flow chart diagram of a method of pre-processing a test file.

FIG. 6 is a flow chart diagram of a method of pre-processing a test file.

FIG. 7 is a flow chart diagram of test execution method.

FIG. 8 is a schematic block diagram illustrating a suitable operating environment for aspects of the subject disclosure.

### DETAILED DESCRIPTION

Software tests can be composed of data, instructions, or a mix of data and instructions. For example, a simple baseline test can involve sending input data to a system under test and comparing its output with the expected output. As another example, actions can be performed that correspond to one or more instructions, and actual results compared with expected results. While data-only and instruction-only test formats are trivial to design and implement, mixing data and instructions presents unique challenges, such as how to separate data and instructions, how to refer to areas of data when issuing instructions, and how to keep the two types of inputs comingled, among other things.

Previous efforts to address challenges of mixing data and instructions have been awkward at best. Some use a data-only format such as XML (eXtensible Markup Language) to encode instructions, thereby limiting the allowed complexity of the instruction set. Others have used an instruction-only format such as a general-purpose programming language to encode data. However, general-purpose programming languages are conventionally ill suited to working with large amounts of data, for instance where data is injected as a string into a local variable and operations are performed on the string. Finally, some tests use a separate data file and a separate instruction file, making it difficult to understand which instructions correspond to which data, complicating maintenance and comprehension.

Details below generally pertain to combined data and instruction test content. Data and instructions can be collocated, for example in a single file. Furthermore, a programming language can be employed wherein instructions are encoded in the programming language syntax and data portions are delimited by a particular character or sequence of characters denoting non-executing code. In one embodiment, data can be encoded within one or more comments. Further, the data can be distinctly annotated to enable data to be distinguished from conventional comments or like constructs. The programming language instructions can be specified to operate on the data. Additionally, metadata can be injected with respect one or both of data and instructions to at least aid specification of instructions that interact with data. A test that mixes data and instructions can be subject to pre-processing to acquire data and compile instructions, among other things. Subsequently, data can be loaded with respect to a system under test and instructions executed on the data in an attempt to verify correct operation of the system under test.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

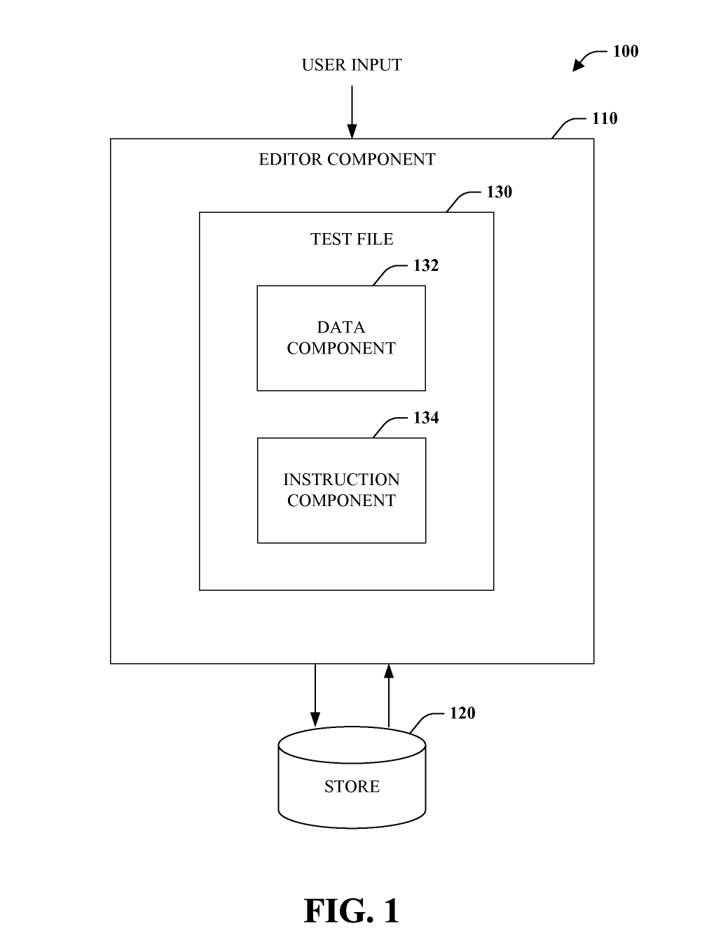

Referring initially to FIG. 1, a test generation system 100 is illustrated. The system 100 includes an editor component 110 configured to provide text editing functionality with respect to one or more computer programming languages, for example. Although not limited thereto, in one instance the editor component 110 can form part of an integrated development environment (IDE). The editor component 110 can receive input from a user as well as save and retrieve files with respect to a computer-readable storage medium, here store 120. A user can employ the editor component 110 to author a test file 130, or, in other words, a computer-programming-language source code file encoded with test functionality. Alternatively, a user can modify a previously authored test file with assistance from the editor component 110.

The test file 130 can include data component 132 and instruction component 134. The instruction component 134 can comprise one or more source code instructions encoding test functionality. The data component 132 encodes data that can be operated on by one or more instructions in the instruction component 134. Further, the data can be embedded within one or more comments or like programming language construct that is not subject to execution and is typically ignored by compilers and interpreters. Further yet, data can be distinctly annotated with at least one predetermined character. In this manner, a data portion can be distinguished from conventional comments employed to make code easier to understand or like constructs. In one non-limiting example, where a conventional line comment is denoted with two forward slashes “//,” two additional forward slashes can be added resulting in four forward slashes “////” to distinguish data from conventional comments.

By collocating data and instructions that operate on the data, the test authoring and readability experiences is simplified as compared to conventional techniques, which necessitate authoring and maintenance of separate files for data and instructions or where data and instructions are not separately present (e.g., data injected into instructions). Furthermore, by encoding a test in programming language source code, the flexibility and functionality afforded by programming language can be exploited for testing.

Metadata can be added to one or more of the data component 132 and the instruction component 134 for a number of purposes. Generally, the metadata can refer to data about data and/or instructions. In one instance, the metadata can correspond to a marker. A marker is an anonymous or named element that identifies a particular location in data. The marker can be specified with respect to data and one or more instructions. In this manner, an instruction can specify a marker to go to, which is a location specified with a corresponding marker name in data. Moreover, a marker is not strictly positional as in designating specific line and position numbers but rather provided a simplified way to track and interact with data locations in a manner analogous to a bookmark. Metadata can also correspond to a file name thereby enabling multiple collections of data to be defined by name and employed by one or more instructions. Additionally, metadata can also correspond to a bug comment, which indicates a known bug, or defect, with respect to test. Consequently, even if the test passes, the result will be failure due to the identified defect. Still further, metadata can correspond to various options regarding the test such as, but not limited to, a compilation target.

Several examples of a test files including a combination of data and instructions and associated with particular test cases are provided below. These are simple examples presented to solely to aid clarity and understanding of various disclosed aspects. Accordingly, the examples are not intended to limit the scope of the claimed subject matter. Furthermore, the examples pertain to a testing programming language or more specifically a programming language service provided by an editor or an integrated development environment. However, this is just one of a plurality of domains to which the aspects are applicable.

Consider the following first example of test file content:

//// var x = ‘hello’ ;
//// var y = x + ‘world’ ;
//// y.substr (/*1*/) ;
goTo.marker (‘1’) ;
verify.parameterHelpType (‘number’) ;

The first three lines include four forward slashes defining the data portion of this test, wherein the first two forward slashes indicate a convention line comment and the additional two forward slashes indicate that the comment corresponds to test data. Since this test is designed to test a language service associated with an editor, the data is embodied as code that a user would enter within an editor. The data also includes a marker encoded as a comment within a comment line (e.g., /*1*/) which declares a location in the data, or here code, where testing can be employed. The last two lines are instructions that define imperatively the text functionality. Here, a parameter help feature is to be tested in the case where the type of operand of the method being invoked was inferred. More particularly, since the type of “x” is string, the type of “y” should be “string,” and thus the type of the first argument to “substr” (a method defined on the string type) should be “number.” The first instruction “goTo.marker(“1”)” places the cursor, or caret, where maker “1” is located. In response, the language service can provide a pop-up box or window that identifies a parameter type. The second instruction seeks to verify that the parameter help type provided is “number.” If the type is “number,” the language service passed the test. Otherwise, the language service failed the test.

The next example seeks to test whether the correct member is supplied by a language service.

//// enum Foo (A, B, C};
//// var n = Foo.A;
//// var k = n./**/
goTo.marker ( ) ;
//Bug 15037: ......
verify.not.memberListContains (‘C’) ;

Similar to the first example, the first three lines include data embedded in comment lines as denoted by the four forward slashes. Further, the data portion includes an anonymous marker specified by the syntax of a forward slash followed by two stars and another forward slash (/**/). The last three lines include instructions and a bug comment. The first instruction moves the cursor or caret to the location following the period after “n.” The second instruction verifies there is not a member “C” included in a member list. A populated member list would be displayed upon positioning the cursor following the period at which point the list can be analyzed to determine if “C” is in the list. The test is failed if “C” is in the list, and otherwise, the test is passed. Here, however, the bug comment indicates that there is a defect with the test. Thus, regardless of the output of the test, the test will fail because of the bug comment.

The final example specifies a navigation test to validate a “Go to Definition” feature. Consider the following test file code:

// @Filename: Definition.ts
//// /*2*/class c { }
// @Filename: Consumption.ts
//// var n = new /*1*/c( ) ;
goTo.marker (‘1’);
goTo.definition ( );
verify.caretAtMarker (‘2’);

In this example, there are two blocks of data defined by in a comment followed by “@Filename:,” namely “Definition.ts” and “Consumption.ts.” There are also three instructions that operator over the data. The first instruction moves the cursor to the first marker between “new” and “c( )” in the “Consumption.ts” data block. The second instruction navigates to the first block of data, namely “Definition.ts.” The third instruction seeks to verify that the cursor, or caret, is positioned at second marker. Subsequently the test can be passed or failed appropriately. In general, this test illustrates the use of multiple files and multiple markers to validate a specific language service feature.

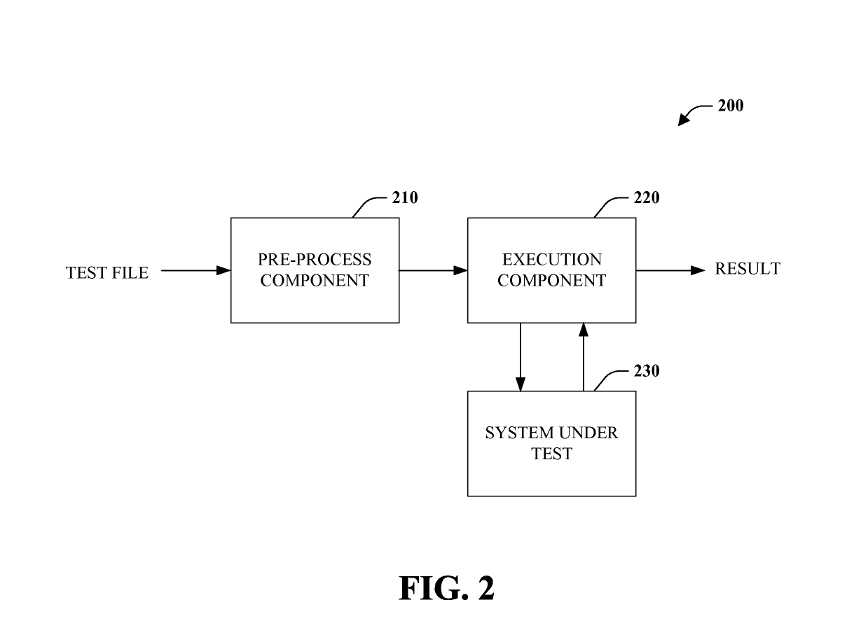

Turning attention to FIG. 2, a test execution system 200 is depicted. The system 200 includes pre-process component 210, execution component 220, and system under test 230. The pre-process component 210 is configured to process a test file comprising a combination of data and instructions prior to execution. As will be described further herein, the pre-process component 210 can extract data specified in the file, for example encoded as a special comment, and compile instructions into executable instructions, among other things. The output of the pre-process component includes data separate from yet collocated with executable code, for instance within the same storage container (e.g., folder). The execution component 220 is configured to execute the test specified by the test file with respect to a system under test 230, such as, but not limited to, a particular software application. More specifically, the execution component 220 can cause data to be loaded on the system under test 230. Subsequently, execution of the instructions on the data can be initiated by the execution component 220. Finally, the execution component 220 can log or otherwise output the result of the test (e.g., pass/fail).

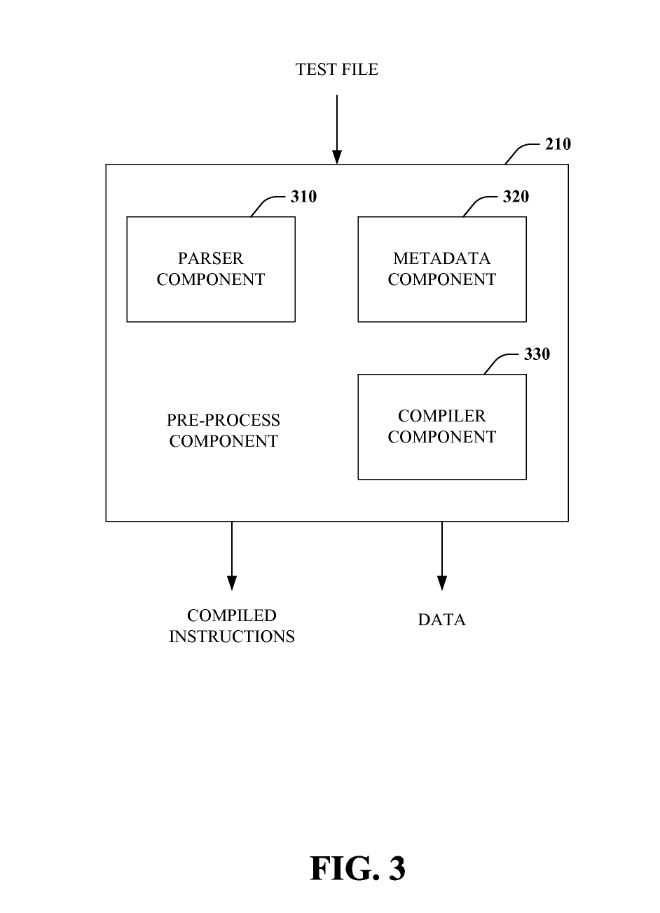

FIG. 3 illustrates a representative pre-process component 210 that can be employed by the test execution system 200 of FIG. 2. The pre-process component 210 can comprise a number of sub-components including parser component 310, metadata component 320, and compiler component 330.

The parser component 310 is configured to identify and capture data encoded within a programming-language source file by way of lexical, syntactic, and sematic analysis associated with parsing. For example, upon identification of comment line syntax and one or more predetermined characters that indicate that data follows, the remainder of line can be captured as data and saved to another file. In one instance, the data can be removed from the file. However, the data need not be removed especially in the case where the data is encoded within one or more comments that are non-executable. In this instance, the data can simply be copied.

The metadata component 320 can operate in conjunction with the parser component to 310 to identify and remove or replace metadata present in a data portion or instruction portion. For example, metadata corresponding to a marker can be removed from the data portion and replaced in the instruction portion with an explicit position (e.g., line 2, column 4). Similarly, reference to code blocks from the instruction portion can be replaced with positional information with respect to the data. In another instance, a parser can identify metadata corresponding to a bug comment. Here, the metadata component 320 can be configured to add or modify an instruction to ensure that the test is not denoted as passed since, there is a known bug associated with the test.

The compiler component 330 is configured to compile instructions into executable instructions targeting a particular machine or execution environment (e.g., virtual machine . . . ). Further, compiled instructions can be stored alongside data. In other words, a file comprising the compiled instructions and a file comprising the data can be local to each other, for example within the container (e.g., folder) on a machine.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the pre-process component 210 can employ such mechanisms in conjunction with identification of data in file comprising a combination of data and instructions. For instance, such mechanisms can be utilized to identify data specified as comments without any distinguishing annotation.

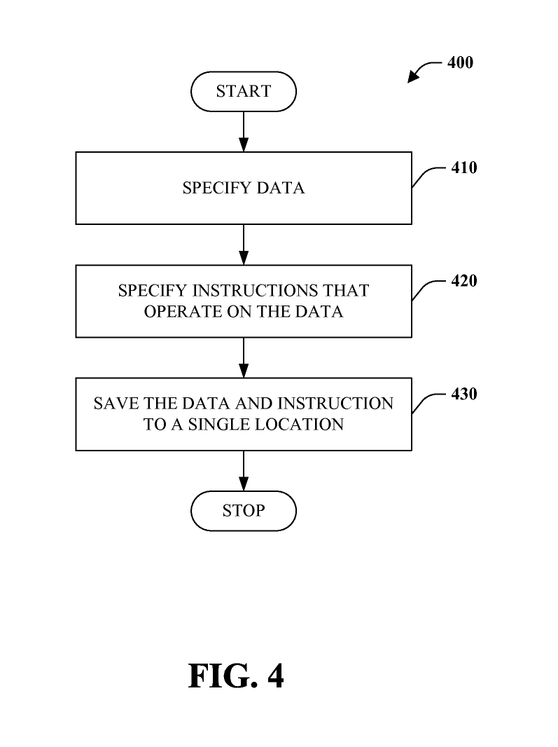

In view of the exemplary systems described above, methodologies that may be implemented in accordance with the disclosed subject matter will be better appreciated with reference to the flow charts of FIGS. 4-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4, a test generation method 400 is illustrated. At reference numeral 410, data is specified within a programming-language source file. The data can be encoded utilized comment syntax of the programming language or any other program construct that indicates that the content is non-executing code. In one instance, at least one predetermined character can also be injected that indicates that the content is data. For example, where a line comment is two forward slashes (“//”), an additional two forward slashes can be added to indicate that which follows is data. At reference numeral 420, instructions, which can operate on the data, are specified in the programming-language syntax. At 430, the data and instructions are saved to a single location as a single source file, for example.

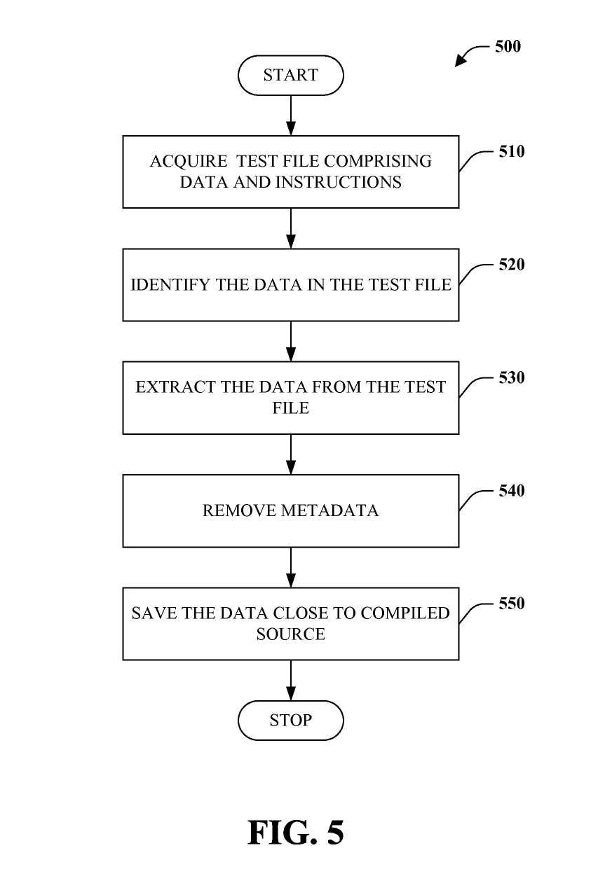

FIG. 5 depicts a method of pre-processing a test file 500. At numeral 510, a test file comprising a combination of data and instructions encoded in a programming language is received, retrieved, or otherwise obtained or acquired. At 520, data in the test file is identified. For example, the data can be identified by locating comments with at least one predetermined alphanumeric character following comment line syntax. At numeral 530, the identified data is extracted from the test file excluding comment and additional character syntax preceding or surrounding the data. In one instance, extraction can include removing the data from the source. However, in another instance, extraction can correspond to capturing the data without removing it from the source. At reference 540, any metadata included within the data, such as, but not limited to markers, can be removed. The extracted data can next be saved close, or local, to a complied version of the source file for convenient retrieval.

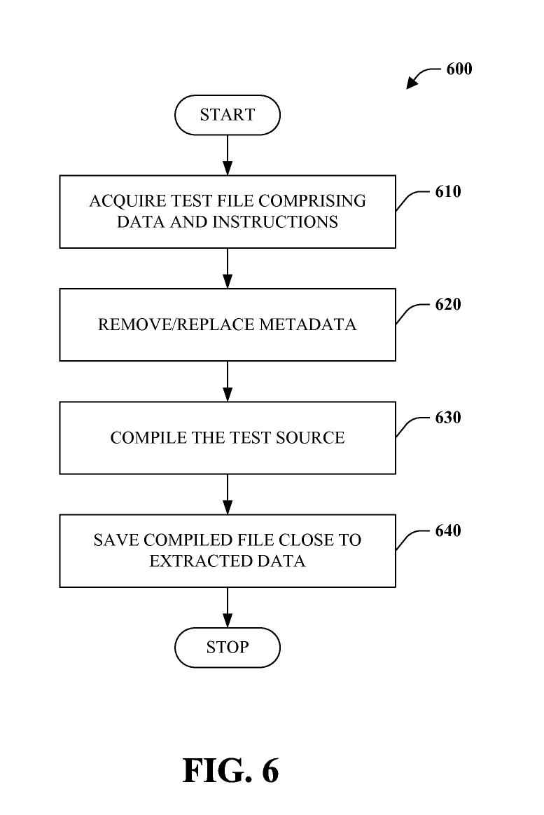

FIG. 6 is a flow chart diagram illustrating a method of pre-processing a test file 600. At reference numeral 610, a test file comprising a combination of data and instructions encoded in a programming language is received, retrieved, or otherwise obtained or acquired. At 620, any metadata present with respect to one or more instructions can be removed or replaced. For example, if the metadata correspond to a marker, the marker can be removed and replaced with positional information with respect to data. In other words, rather than have an anonymous or name element marker referencing a corresponding marker in the data, the marker can be replaced with the location of the marker in the data (e.g., first line, second position). Likewise, reference to a named block of data can be replaced by the location of the block of data. At reference numeral 630, the instructions in the test source are compiled for execution on a particular machine or execution environment (e.g., virtual machine). The compiled source is then saved to a location close, or local, to corresponding extracted data at numeral 640. In accordance with one aspect, the metadata specified with instructions can identify compilation options that can be employed by the compiler, such as identifying a compilation target.

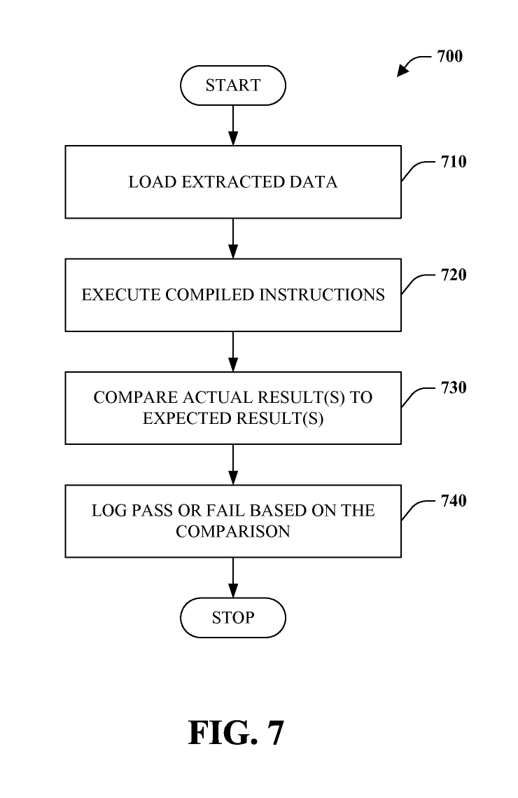

FIG. 7 depicts a method of test execution 700. At reference numeral 710, extracted data can be loaded with respect to a system under test. For example, if the system under test is a word processing application, data corresponding to text can be loaded within a new word processing document. At numeral 720, compiled instructions are executed against the loaded data. For example, a word can be selected and particular operations made available after selection of the word analyzed. At numeral 730, one or more actual results returned by exercising a system with a test are compared to one or more expected results. At reference numeral 740, whether the system passed or failed the test based on the comparison of actual and expected results is logged or otherwise output.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

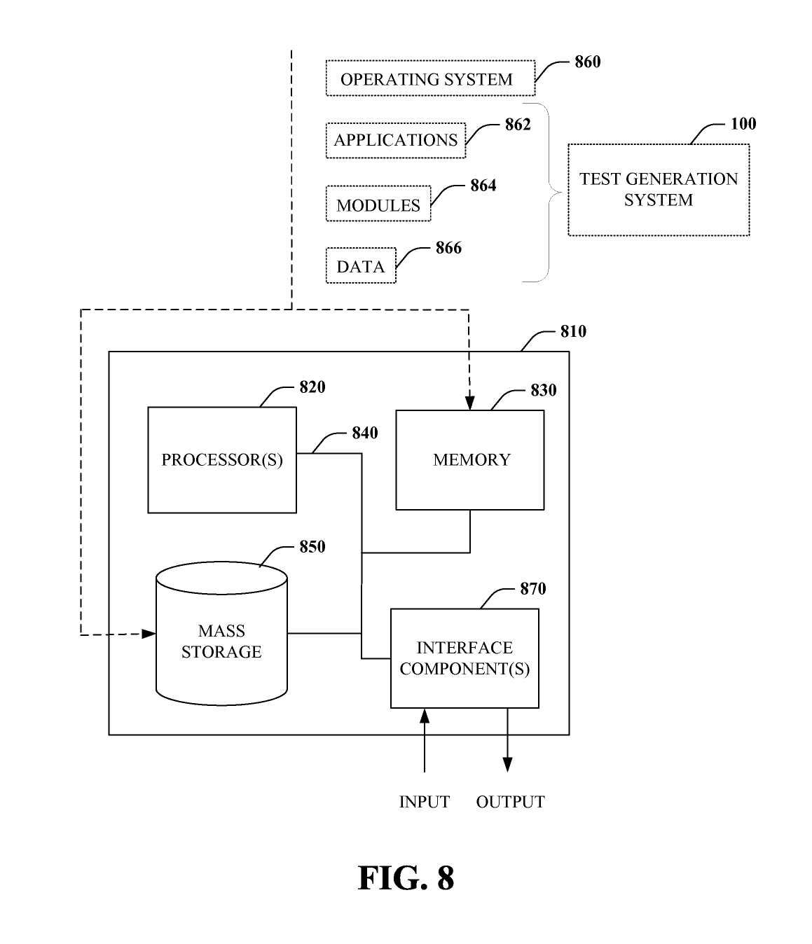

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, tablet, server, hand-held, programmable consumer or industrial electronics, set-top box, game system, compute node . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 810. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the test generation system 100, or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the test generation system 100 and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, LED, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
receiving a programming language source file that encodes a test in terms of a combination of data and instructions; and
processing the file prior to execution of the test.

2. The method of claim 1, the processing comprises extracting the data from the language source file.

3. The method of claim 1, the processing comprises identifying the data embedded within at least one comment in the file.

4. The method of claim 3 further comprising identifying the data as a function of a distinct annotation within the at least one comment.

5. The method of claim 1 further comprises identifying and removing metadata within the data.

6. The method of claim 5, identifying and removing metadata that denotes a marker.

7. The method of claim 1, the processing comprises identifying a marker in at least one of the instructions and replacing the marker with a corresponding location in the data.

8. The method of claim 1, the processing comprises compiling the source file.

9. A test system, comprising:
a processor coupled to a memory, the processor configured to execute the following computer-executable component stored in the memory:
a first component configured to determine whether a system operates correctly as a function of a test encoded in terms of a combination of data and instructions in a programming-language source file.

10. The system of claim 9, the data is embedded within one or more comments.

11. The system of claim 10, the data is encoded with one or more predetermined characters with the one or more comments.

12. The system of claim 9 further comprises a second component configured to acquire the data from the source file.

13. The system of claim 9 further comprises a second component configured to remove metadata included within the data.

14. The system of claim 9 further comprises a second component configured to remove metadata specified in conjunction with the instructions.

15. The system of claim 14, the second component is further configured to replace a marker with a location in the data identified by the marker.

16. The system of claim 9 further comprises a second component configured to compile the instructions.

17. A computer-readable storage medium having a computer program stored thereon comprising:
data embedded within one or more program comments; and
computer-executable instructions configured to perform one or more actions on the data in conjunction with a software-application-under-test.

18. The computer-readable storage medium of claim 17, the data includes a distinct annotation that indicates that data is embedded within the one or more program comments.

19. The computer-readable storage medium of claim 17, the computer program further comprises metadata in conjunction with at least one of the data or instructions.

20. The computer-readable storage medium of claim 19, the metadata is a marker that identifies a location within the data.
